(19) United States
(12) Patent Application Publication
(10) Pub. No.: US 2026/0274317 A1
(43) Pub. Date: Sep. 17, 2026

(54) DOLLY CART FOR TRANSPORTING A MULTI-GALLON BUCKET

(71) Applicants: Gabriel Galvan, Fontana, CA (US); Ricardo Menchaca, Upland, CA (US); Oswaldo Plascencia, Upland, CA (US)

(72) Inventors: Gabriel Galvan, Fontana, CA (US); Ricardo Menchaca, Upland, CA (US); Oswaldo Plascencia, Upland, CA (US)

(21) Appl. No.: 19/078,487

(22) Filed: Mar. 13, 2025

(51) Int. Cl. B62B 1/26; B62B 1/10; B62B 5/06

(52) U.S. Cl. CPC B62B 1/264; B62B 1/10; B62B 5/067

(57) ABSTRACT

A dolly cart for transporting a multi-gallon bucket includes a cart body, a pair of wheels, and a handle. The cart body includes a top wall, a bottom wall, a rear wall, a pair of side walls, and a front wall. The bottom wall includes a semi-circular projection extending convexly beyond the top wall, the front wall, and the side walls. The front wall is concave to form with the bottom wall a receptacle shaped to receive and hold a multi-gallon bucket. The wheels are rotatably mounted on the cart body at the bottom wall. The handle is coupled to the cart body to manually push the cart body. The handle is positioned to extend vertically away from the top wall.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) the Names of the Parties to a Joint Research Agreement

Not Applicable

### (e) Incorporation-by-reference of Material Submitted on a COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to carts for transporting buckets and more particularly pertains to a new dolly cart for transporting a multi-gallon bucket. Five-gallon buckets are very common in the U.S. and around the world. However, they can be very heavy and difficult to carry around when filled or partially filled. The new dolly cart provides a very secure and easy way to transport such buckets.

### (2) Description of Related Art Including Information Disclosed under 37 CFR 1.97 and 1.98

The prior art relates to carts and dollies for transporting buckets. The prior art, as best understood, does not disclose a dolly cart for transporting a multi-gallon bucket includes a cart body, a pair of wheels, and a handle, wherein the bottom wall includes a semi-circular projection extending convexly beyond the top wall, the front wall, and the side walls, and the front wall is concave to form with the bottom wall a receptacle shaped to receive and hold a multi-gallon bucket.

### (h) BRIEF SUMMARY OF THE INVENTION

An embodiment of the disclosure meets the needs presented above in a dolly cart generally comprising a cart body, a pair of wheels, and a handle. The cart body includes a top wall, a bottom wall, a rear wall, a pair of side walls, and a front wall. The bottom wall includes a semi-circular projection extending convexly beyond the top wall, the front wall, and the side walls. The front wall is concave to form with the bottom wall a receptacle shaped to receive and hold a multi-gallon bucket. The wheels are rotatably mounted on the cart body at the bottom wall. The handle is coupled to the cart body to manually push the cart body. The handle is positioned to extend vertically away from the top wall.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top front perspective view of a dolly cart according to an embodiment of the disclosure.

FIG. 2 is a top front perspective view of an embodiment of the disclosure.

FIG. 3 is a bottom rear perspective view of an embodiment of the disclosure.

FIG. 4 is a top rear perspective view of an embodiment of the disclosure.

FIG. 5 is a front view of an embodiment of the disclosure.

FIG. 6 is a side cross-sectional view of an embodiment of the disclosure.

FIG. 7 is a side view of an embodiment of the disclosure in use.

### (J) DETAILED DESCRIPTION OF THE INVENTION

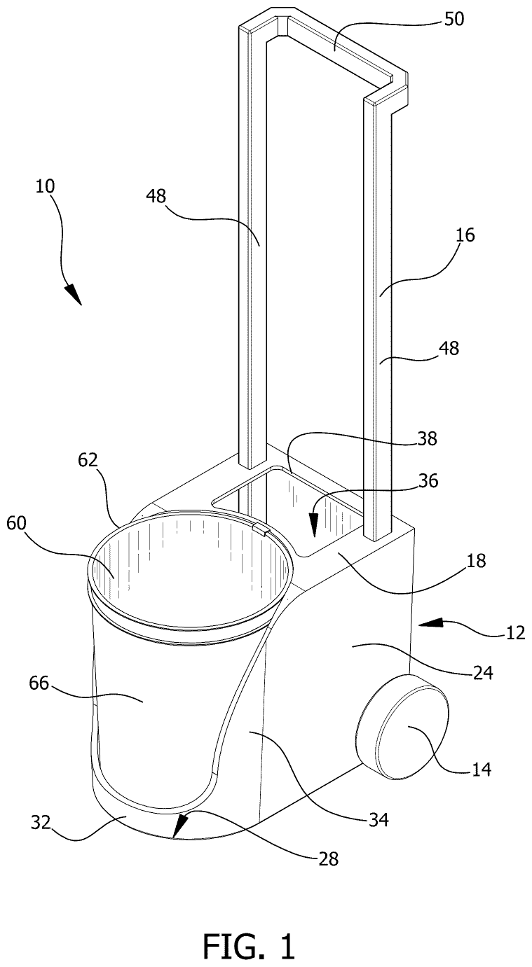

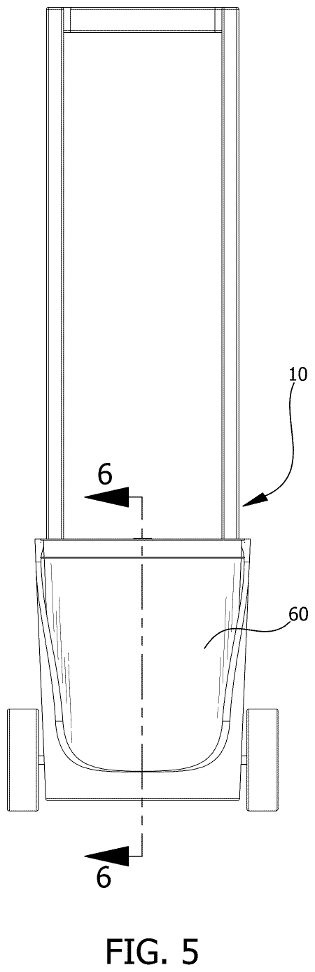

With reference now to the drawings, and in particular to FIGS. 1 through 6 thereof, a new dolly cart embodying the principles and concepts of an embodiment of the disclosure and generally designated by the reference numeral 10 will be described.

As best illustrated in FIGS. 1 through 6, the dolly cart 10 for transporting a multi-gallon bucket 60 generally comprises a cart body 12, a pair of wheels 14, and a handle 16. The cart body 12 includes a top wall 18, a bottom wall 20, a rear wall 22, a pair of side walls 24, and a front wall 26. The bottom wall 20 includes a semi-circular projection 28 extending convexly beyond the top wall 18, the front wall 26, and the side walls 24. The front wall 26 is concave to form with the bottom wall 20 a receptacle 30 shaped to receive and hold a multi-gallon bucket 60. The wheels 14 are rotatably mounted on the cart body 12 at the bottom wall 20. The handle 16 is coupled to the cart body 12 to manually push the cart body 12. The handle 16 is positioned to extend vertically away from the top wall 18.

In the exemplary embodiment, the receptacle 30 is designed to receive and hold a multi-gallon bucket 60 that can contain at least 5.0 gallons (18.93 liters) of a liquid. As discussed herein, five-gallon buckets are very common in the U.S. and around the world, and thus the exemplary embodiment of the dolly cart 10 is designed to hold such buckets, though the dolly cart 10 could easily be sized to hold buckets that contain more or less than five gallons. It should be noted that for convenience of illustration, the bucket 60 is shown in the figures in the dolly cart 10, though the bucket 60 is not part of the dolly cart 10 itself, which is designed to hold any bucket 60 of the appropriate dimensions. However, in one possible embodiment, the dolly cart 10 could be part of a transport system that includes both the dolly cart 10 and the bucket 60 sold as a unit.

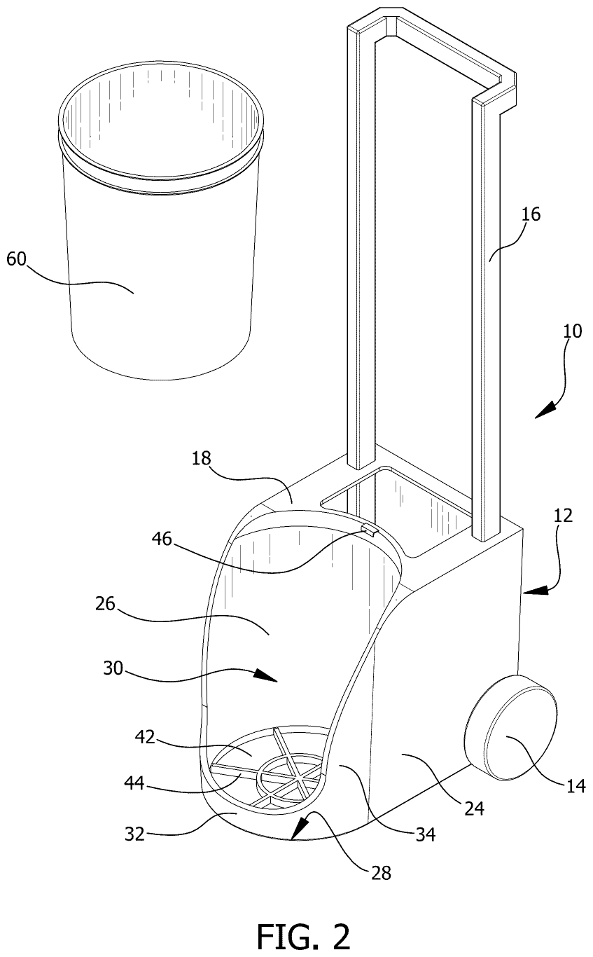

In the exemplary embodiment in FIG. 2, the front wall 26 is semi-circular and extends from one of the side walls 24 to the other. The front wall 26 therefore surrounds or covers about half of the bucket 60, while the other half of the bucket 60 is exposed. Such a design allows the bucket 60 to be inserted laterally from the front of the dolly cart 10 rather than being dropped down from above if the receptacle 30 extended around like a cylinder or cup.

As shown in FIG. 2, the dolly cart 10 further includes a lip 32. The lip 32 extends vertically from a perimeter edge of the semi-circular projection 28 of the bottom wall 20. The lip 32 is part of the receptacle 30. The lip 32 helps prevent the bucket 60 from sliding out of the receptacle 30. In one possible embodiment, the lip 32 could be omitted.

Also as shown in FIG. 2, the dolly cart 10 includes a pair of curved flanges 34. Each of the curved flanges 34 extends horizontally from a respective one of the side walls 24 of the cart body 12 and extends vertically from the lip 32. The curved flanges 34 are part of the receptacle 30. The curved flanges 34 provide additional stability and holding force beyond what is provided by the lip 32 and the front wall 26.

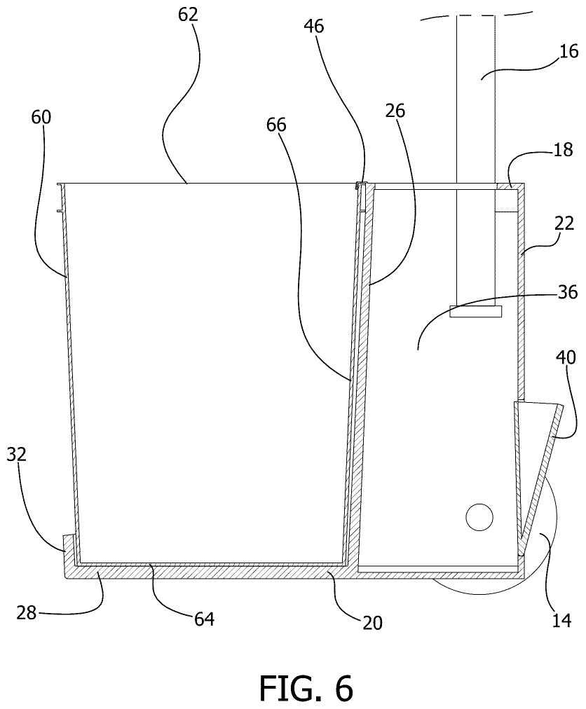

As shown in FIGS. 2 and 6, the top wall 18, the bottom wall 20, the rear wall 22, the side walls 24, and the front wall 26 enclose a storage space 36. The top wall 18 includes an orifice 38 for insertion of items into the storage space 36. In one possible embodiment, the storage space 36 could be omitted. In another possible embodiment, the orifice 38 could be covered by a lid.

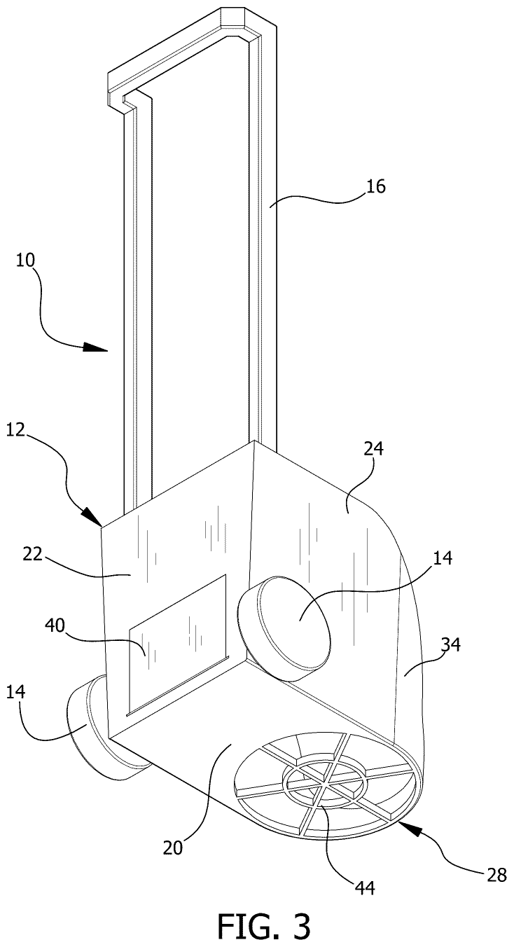

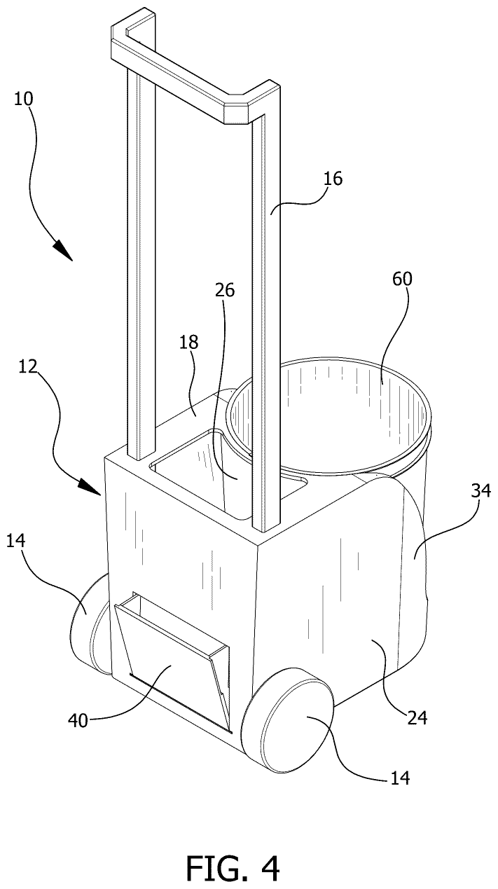

As shown in FIGS. 3 and 4, the dolly cart 10 further includes a drawer 40. The drawer 40 is designed to store items. The drawer 40 is pivotably mounted in the rear wall 22 to selectively open and close the drawer 40. In another possible embodiment, the drawer 40 could be omitted, could be placed in one of the side walls 24, or could be open and connected to the storage space 36.

As shown in FIG. 3, the bottom wall 20 includes a plurality of apertures 42 to provide ventilation and drainage under the multi-gallon bucket 60. In the exemplary embodiment, a grid 44 or lattice formed by elongated pieces is located in a circular opening in the bottom wall 20. However, this is only one exemplary embodiment, and other possible embodiments could have a different design, such as a plurality of circular holes or elongated slots in the bottom wall 20.

As shown in FIGS. 1 and 2, the dolly cart 10 further includes a bracket 46. The bracket 46 is positioned adjacent the top wall 18 and projects from the front wall 26. The bracket 46 is designed to engage a rim 62 of the bucket 60 when the multi-gallon bucket 60 is in the receptacle 30. The bracket 46 assists in retaining the bucket 60 in the receptacle 30. In one possible embodiment, the bracket 46 could be omitted. The bracket 46 could be plastic, though in another possible embodiment the bracket 46 could be made of a resilient material, such as a rubber or elastomer.

The handle 16 is retractable and extendable into and out of the cart body 12. The exemplary embodiment shows the handle 16 as having two legs 48 and a crosspiece 50, though other handle 16 designs, such as a T-shaped handle 16, are within the scope of the disclosure.

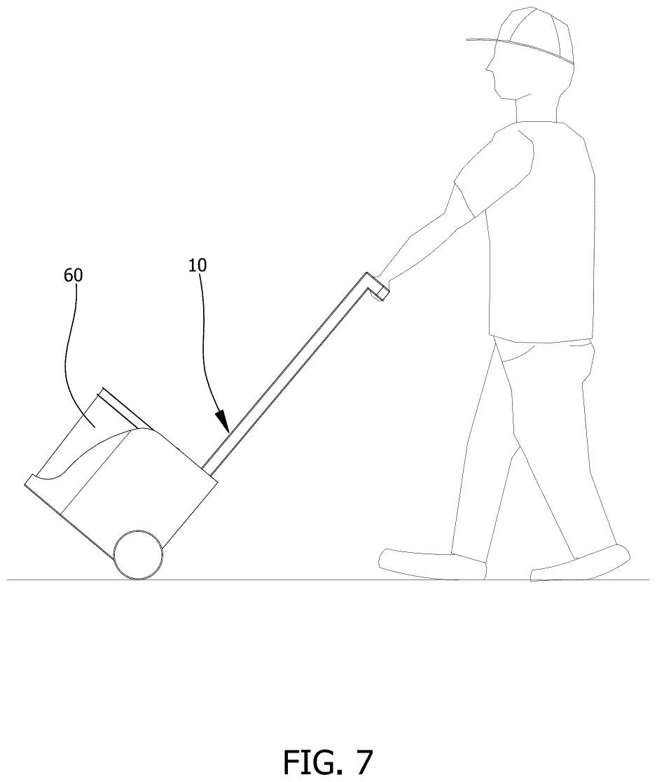

Each of the wheels 14 is positioned on a respective one of the side walls 24 at an intersection between the bottom wall 20 and the rear wall 22 such that the cart body 12 can be tipped off of a support surface and rolled on the wheels 14, as shown in FIG. 7. In one possible embodiment, an additional caster wheel could be included and mounted on the bottom wall 20 adjacent the lip 32.

As discussed herein, the dolly cart 10 is used for transporting a multi-gallon bucket 60, such as a five-gallon bucket 60. The user simply places the bucket 60, either before or after filling, into the receptacle 30 of the dolly cart 10, with a bottom 64 of the bucket 60 resting on the bottom wall 20 and a portion of a side 66 of the bucket 60 against the front wall 26. The user then rolls the dolly cart 10 to another location, as shown in FIG. 7, thereby alleviating the stress of carrying around the bucket 60 by hand.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A dolly cart for transporting a multi-gallon bucket comprising:
a cart body, said cart body including a top wall, a bottom wall, a rear wall, a pair of side walls, and a front wall, said bottom wall including a semi-circular projection extending convexly beyond said top wall, said front wall, and said side walls, said front wall being concave to form with said bottom wall a receptacle shaped to receive and hold a multi-gallon bucket;
a pair of wheels, said wheels being rotatably mounted on said cart body at said bottom wall; and
a handle, said handle being coupled to said cart body to manually push said cart body, said handle being positioned to extend vertically away from said top wall.

2. The dolly cart of claim 1, wherein said receptacle is configured to receive and hold a multi-gallon bucket designed to contain at least 5.0 gallons (18.93 liters) of a liquid.

3. The dolly cart of claim 1, further comprising a lip, said lip extending vertically from a perimeter edge of said semi-circular projection of said bottom wall, said lip being part of said receptacle.

4. The dolly cart of claim 3, further comprising a pair of curved flanges, each of said curved flanges extending horizontally from a respective one of said side walls of said cart body and extending vertically from said lip, said curved flanges being part of said receptacle.

5. The dolly cart of claim 1, wherein said front wall is semi-circular and extends from one of said side walls to the other.

6. The dolly cart of claim 1, wherein:
said top wall, said bottom wall, said rear wall, said side walls, and said front wall enclose a storage space; and
said top wall includes an orifice for insertion of items into said storage space.

7. The dolly cart of claim 1, further comprising a drawer, said drawer being configured to store items, said drawer being pivotably mounted in said rear wall to selectively open and close said drawer.

8. The dolly cart of claim 1, wherein said bottom wall includes a plurality of apertures to provide ventilation and drainage under the multi-gallon bucket.

9. The dolly cart of claim 1, further comprising a bracket, said bracket being positioned adjacent said top wall and projecting from said front wall, said bracket being configured to engage a rim of the multi-gallon bucket when the multi-gallon bucket is in said receptacle.

10. The dolly cart of claim 1, wherein said handle is retractable and extendable into and out of said cart body.

11. The dolly cart of claim 1, wherein each of said wheels is positioned on a respective one of said side walls at an intersection between said bottom wall and said rear wall such that said cart body can be tipped off of a support surface and rolled on said wheels.

12. The dolly cart of claim 2, further comprising a lip, said lip extending vertically from a perimeter edge of said semi-circular projection of said bottom wall, said lip being part of said receptacle.

13. The dolly cart of claim 12, further comprising a pair of curved flanges, each of said curved flanges extending horizontally from a respective one of said side walls of said cart body and extending vertically from said lip, said curved flanges being part of said receptacle.

14. The dolly cart of claim 13, wherein said front wall is semi-circular and extends from one of said side walls to the other.

15. The dolly cart of claim 14, wherein:
said top wall, said bottom wall, said rear wall, said side walls, and said front wall enclose a storage space; and
said top wall includes an orifice for insertion of items into said storage space.

16. The dolly cart of claim 15, further comprising a drawer, said drawer being configured to store items, said drawer being pivotably mounted in said rear wall to selectively open and close said drawer.

17. The dolly cart of claim 16, wherein said bottom wall includes a plurality of apertures to provide ventilation and drainage under the multi-gallon bucket.

18. The dolly cart of claim 17, further comprising a bracket, said bracket being positioned adjacent said top wall and projecting from said front wall, said bracket being configured to engage a rim of the multi-gallon bucket when the multi-gallon bucket is in said receptacle.

19. The dolly cart of claim 18, wherein said handle is retractable and extendable into and out of said cart body.

20. The dolly cart of claim 19, wherein each of said wheels is positioned on a respective one of said side walls at an intersection between said bottom wall and said rear wall such that said cart body can be tipped off of a support surface and rolled on said wheels.
